(19) United States
(12) Patent Application Publication
(10) Pub. No.: US 2016/0224732 A1
(43) Pub. Date: Aug. 4, 2016

(54) PREDICTING RELATED SYMPTOMS

(71) Applicant: Practice Fusion, Inc., San Francisco, CA (US)

(72) Inventors: Sarah XING, Palo Alto, CA (US); Richard Loomis, Alameda, CA (US)

(73) Assignee: Practice Fusion, Inc., San Francisco, CA (US)

(21) Appl. No.: 14/611,954

(22) Filed: Feb. 2, 2015

(51) Int. Cl. G06F 19/00; G06F 17/30

(52) U.S. Cl. CPC G06F 19/322; G06F 19/3437; G06F 17/3053

(57) ABSTRACT

In an embodiment, a computer-implemented method predicts a related symptom. In the method, the EHR system determines a plurality of mapping entries to build a predictive model. Each mapping entry specifies a correlation between a first symptom and a second symptom in at least one patient encounter note. After building the predictive model, the EHR system receives a reported symptom. Then, the EHR system selects which of the plurality of mapping entries corresponds to the reported symptom to generate a related symptom. The selected mapping entry correlates the related symptom with the reported symptom.

### BACKGROUND

1. Field

This field is generally related to a symptom prediction tool that predicts related symptoms.

2. Background

### Electronic Health Records

Medical records related to a patient's health information are essential to the practice of medical care. Traditionally, medical records were paper-based documents. The emergence of electronic medical records (EMR), which are digital version of the paper chart that contains all of a patient's medical history from one medical practice, offers medical professionals and patients with new functionalities and efficiencies that paper-based medical records cannot provide. An electronic health record (EHR), also known as an electronic medical record (EMR), is a collection of electronically stored information about an individual patient's medical history. EHRs may contain a broad range of data, including demographics, medical history, medication history, allergies, immunization records, laboratory test results, radiology images, vital signs, personal statistics like age and weight and billing information. Many commercial EHR systems combine data from a number of healthcare services and providers, such as clinical care facilities, laboratories, radiology centers and pharmacies.

EHRs are a drastic improvement over paper-based medical records. Paper-based medical records require a large amount of physical storage space. Paper records are often stored in different locations and different medical professionals may each have different and incomplete records about the same patient. Obtaining paper records from multiple locations for review by a healthcare provider can be time consuming, complicated and sometimes impossible. In contrast, EHR data is stored in digital format and thus are more secure and can be accessed from anywhere. EHR systems significantly simplify the reviewing process for healthcare providers. Because records in EHRs can be linked together, EHRs vastly improve the accessibility of health records and the coordination of medical care.

EHRs also decrease the risk of misreading errors by healthcare professionals. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations and data input, which help ensure reliability of medical records and standardization of codesets and storage of EHR data means that data from different technical information systems can be displayed in a single, unified record. Further, EHRs can be transferred electronically, thus reducing delays and errors in recording prescriptions or communicating laboratory test results.

The benefits of digitizing health records are substantial. Healthcare providers with EHR systems have reported better outcomes, fewer complications, lower costs and fewer malpractice claim payments. But despite EHRs' potential in drastically improving the quality of medical care, only a low percentage of healthcare providers use EHR systems. While the advantages of EHRs are significant, they also carry concerns, including high costs, lost productivity during EHR implementation or computer downtime and lack of EHR usability.

The Health Insurance Portability and Accountability Act (HIPAA), enacted in the U.S. in 1996 and as amended, established rules for use and access of protected health information (PHI). HIPAA provides restrictions on disclosure of and access to protected health information to and by third parties. HIPAA applies to information in electronic medical records, such as health information doctors and nurses input, documented conversations between a doctor and a patient and information use to process or facilitate medical billing claims and documents. The HIPAA Security Rule, effective on Apr. 20, 2005 for most covered entities, adds additional constraints to electronic data security and the storage and transmission of PHI.

The high cost of EHRs also significantly hinders EHR adoption. A large number of physicians without EHRs have referred to initial capital costs as a barrier to adopting EHR systems. Cost concerns are even more severe in smaller healthcare settings, because current EHR systems are more likely to provide cost savings for large integrated institutions than for small physician offices. During the EHR technology's setup and implementation process, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among healthcare provider groups and from function to function within a healthcare provider group. To some providers, using electronic medical records can be tedious and time consuming and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the healthcare system, calls for better EHR systems that are secure, cost-effective, efficient and user-friendly.

Comprehensive EHR systems can provide capabilities far beyond simply storing patients' medical records. Because EHR systems offer healthcare providers and their workforce members the ability to securely store and utilize structured health information, EHR systems can have a profound impact on the quality of the healthcare system. In Framework for Strategic Action on Health information Technology, published on Jul. 21, 2004, the Department of Health & Human Services (HHS) outlined many purposes for EHR services. The outlined purposes include, among other things, improving healthcare outcomes and reducing costs, reducing recordkeeping and duplication burdens, improving resource utilization, care coordination, active quality and health status monitoring, reducing treatment variability and promoting patients' engagement in and ownership over their own healthcare.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HUTCH) Act, passed as a part of ARRA, allocated billions of dollars for healthcare providers to adopt and meaningfully use EHRs in their practices. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support and drug-drug and drug-allergy interaction checks. Patient lists and education resources include the ability to create patient lists based on problems, medications, medication allergies, demographics and laboratory test result values and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits and facilitate secure-doctor patient messaging.

Many EHR systems store patient encounter notes. A patient encounter note describes an encounter between a patient and a health practitioner. For example, an encounter may occur when a patient visits a physician. A patient encounter note usually follows the SOAP (subjective, objective, assessment, and plan) note format. A SOAP note format is a method that healthcare providers employ to write notes in a patient's chart. The four components of a SOAP note are subjective, objective, assessment, and plan. In particular, the subjective component describes the patient's current condition in narrative form. A SOAP note often includes a chief complaint section. A chief complaint section has a very brief statement of a patient as to the purpose of the office visit or hospitalization. The brief statement in the chief complaint section often states the symptom, problem, condition or other factors that are the reason for the encounter. The subjective component may contain additional symptoms pertinent to a symptom reported in the chief complaint section.

Patient encounter notes provide a rich source of patient information. However, due to the free-text nature of patient encounter notes and limitations in clinical natural language processing technology, current EHR systems do not leverage enough the information in the patient encounter notes stored in the EHR systems.

### BRIEF SUMMARY

In an embodiment, a computer-implemented method predicts a related symptom. In the method, the EHR system determines a plurality of mapping entries to build a predictive model. Each mapping entry specifies a correlation between a first symptom and a second symptom in at least one patient encounter note. After building the predictive model, the EHR system receives a reported symptom. Then, the EHR system selects which of the plurality of mapping entries corresponds to the reported symptom to generate a related symptom. The selected mapping entry or entries correlates the reported symptom with the related symptoms. System and computer program product embodiments are also disclosed.

Further embodiments, features and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a flowchart illustrating a method for predicting a related symptom.

FIG. 2 shows a screen illustrating a user interface utilizing the symptom prediction tool.

FIG. 3 shows an exemplary data structure in the predictive model.

FIG. 4 is a flowchart illustrating a method for selecting mapping entries based on a group of symptoms in the same SNOMED CT hierarchy.

FIG. 5 is a diagram illustrating an example system that implements the symptom prediction tool.

FIG. 6 is a diagram illustrating an example computing device.

FIG. 7 is an illustration of an example medical record.

The drawing in which an element first appears is typically indicated by the leftmost digit or digits in the corresponding reference number. In the drawings, like reference numbers may indicate identical or functionally similar elements.

### DETAILED DESCRIPTION

Conventionally, physicians and patients use free-text format to enter patient information (e.g., symptoms) in patient encounter notes. For example, a physician may enter tree-text patient information in an encounter note-taking GUI in the EHR system. Similarly, a patient may log into a personal health record (PHR) system connected to the EHR system for entering free-text patient information in a patient intake form GUI. However, free-text entry of patient symptoms can be time consuming because a patient may want to report a long list of symptoms. Free-text entry of patient symptoms can also be error prone as many symptoms in medical terms are difficult to spell. Even with the help of EHR systems, many physicians still prefer free-text entry of medical information to minimize potential intrusion to physicians' workflow. On the other hand, patient encounter notes provide a rich source of patient information. Nevertheless, current EHR systems do not utilize information in patient encounter notes to alleviate the burden of EHR users (e.g., a patient or a physician) entering medical information. Consequently, EHR users still have to type in every reported symptom in the user interfaces provided by the EHR system.

To address these issues, embodiments provide a symptom prediction tool. Once the EHR user begins to enter a first symptom into the EHR system, a list of autocomplete options is generated. The user can select one of the autocomplete options as a first symptom. For example, if the user begins typing “co,” the autocomplete list may consist of “cough,” “dry cough,” and “wheezing cough.” The user can select which option most accurately describes his or her cough. After entering one symptom in the EHR system, the symptom prediction tool may generate one or more related symptoms for selection. If the patient is experiencing one of the related symptoms predicted by the symptom prediction tool, the EHR user may select the related symptom by a single click without having to type in the symptom in the free-text format. Additionally, with the help of the symptom prediction tool, the EHR system may also provide the benefit that the suggested one or more related symptoms may allow physicians to ask patients about symptoms that they may have otherwise overlooked or forgotten.

In the detailed description that follows, references to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described.

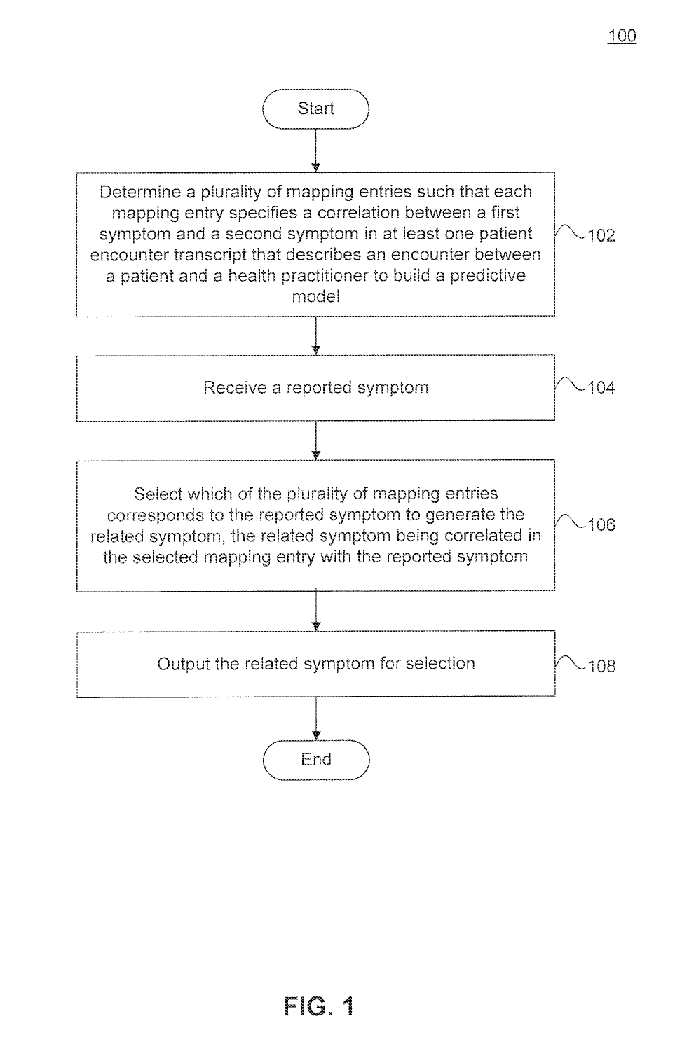

FIG. 1 is a flowchart, illustrating a method 100 for predicting a related symptom.

Method 100 begins at step 102 by building a predictive model. To build the predictive model, the EHR system determines a plurality of mapping entries. Each entry specifies a correlation between a first symptom and a second symptom. To establish a mapping entry, the first symptom and the second symptom must coexist in at least one patient encounter note. A patient encounter note describes an encounter between a patient and a health practitioner (e.g., an office visit between a patient and a physician). Each mapping entry maps a first symptom (e.g., a reported symptom) to a second symptom (e.g., a related symptom) and may also contain a frequency counter indicating the number of occurrences of this mapping relationship.

As described, a patient encounter note often follows the SOAP note format and contains subjective, objective, assessment, and plan components. A SOAP note includes a chief complaint section that states the symptom, problem, condition or other factors that are the reason for the encounter between a patient and a health practitioner. Also, the subjective component may contain other sections that describe additional symptoms pertinent to a symptom reported in the chief complaint section. In one embodiment, the EHR system determines a mapping entry by extracting the first symptom from the chief complaint section. If the subjective component contains additional symptoms, then the EHR system extracts the second and subsequent symptoms from the subjective component. The mapping entry correlates the extracted first symptom with the extracted subsequent symptoms.

In some embodiments, the first symptom and the second symptom are stored in a mapping entry in the SNOMED CT code format. Thus, after the EHR system extracts the first symptom and the second symptom from a patient encounter note, the EHR system further parses the extracted symptoms from the free-text format to corresponding SNOMED CT codes, and stores the parsed corresponding SNOMED CT codes in the mapping entry. SNOMED CT (Systematized Nomenclature of Medicine Clinical Terms) is a systematically organized collection of medical terms. SNOMED CT provides codes, terms, synonyms and definitions used in clinical documentation and reporting. Clinical terms in the SNOMED CT format are computer processable and they provide a standardized way to represent clinical phrases captured by the health practitioners and enable automatic interpretation of these clinical phrases. Under SNOMED CT, each symptom has a corresponding SNOMED CT code. For example, the symptom “cough” corresponds to SNOMED CT code 49727002, and the symptom “wheezing” corresponds to SNOMED CT code of 56018004.

Once the EHR system finishes building the predicative model, a medical staff or a patient may use the symptom prediction tool as an intake tool for inputting symptoms. In addition, a health care provider may use the symptom prediction tool as a diagnosis helper. The EHR system may use the predicative model in the symptom prediction tool to help a patient or a physician to predict related symptoms. A patient may log into a PHR system connected to the EHR system. The patient may then use the symptom prediction tool through the patient intake form in a graphical user interface (GUI) in the PHR system presented to the patient. For example, the patient may report a symptom that the patient is experiencing by entering in a text box in the patient intake form. Upon submitting the patient intake form in the PHR system, the PHR system may then send the reported symptom information to the EHR system. For a physician user of the EHR system, the symptom prediction tool may appear in the transcript note-taking, section of a GUI presented to the physician. When the patient reports a symptom to the physician during the physician-patient encounter, the physician may type in the reported symptom in the note-taking section of the GUI. In either case, the reported symptom is sent to the EHR system. At step 104, the EHR system receives the symptom reported by the patient.

At step 106, EHR system selects which of the plurality of mapping entries in the predictive model corresponds to the reported symptom. If a mapping entry in the predictive model has its first symptom matches the reported symptom, the EHR system may select the mapping entry.

As the user begins entering a reported symptom, the EHR system provides an autocomplete list mapping from the free-text format to a corresponding structured display term and SNOMED CT code. Then the EHR system selects a mapping entry whose first symptom field matches the SNOMED CT symptom code corresponding to the reported symptom. For example, if the EHR system receives symptom “cough” reported by the patient, the EHR system first parses the text “cough” into the SNOMED CT code that corresponds to cough (49727002). Then, the EHR system selects a mapping entry whose first symptom matches the SNOMED CT code of 49727002.

After the selection of a mapping entry, the EHR system may use the selected mapping entry to generate a related symptom. The related symptom corresponds to the reported symptom as indicated in the selected mapping entry. For example, if the selected mapping entry has wheezing in its second symptom field, the EHR system generates wheezing as the related symptom. In the ease that there are multiple mapping entries for each reported symptom (“cough” can map to “wheezing” as well as to “fever”), the related symptom list is ordered by frequency of co-occurrence in notes.

At step 108, the EHR system outputs the related symptom for selection. If the predictive model stores the symptoms in corresponding SNOMED CT codes in its mapping entries, the EHR system may first convert the related symptom in the selected mapping entry from SNOMED CT code into a patient-friendly text format for output. The EHR system may output the related symptom in the patient intake form in the GUI in the PHR system for a patient or in the encounter note-taking section in the GUI for a physician. If the patient is also experiencing the related symptom, the patient or the physician may select the related symptom displayed in the GUI as an additional symptom without having to type the related symptom.

Method 100 describes embodiments that predict one or more related symptoms based on one reported symptom. In other embodiments, the EHR system may predict one or more related symptoms based on two or more reported symptoms. When a patient reports more than one symptoms, the EHR system may search for all mapping entries of which the first symptoms match one of the reported symptoms. The EHR system then aggregates the frequency counter of the second symptom in each of these matching flapping entries. The EHR system may return a final list of the suggested related symptoms as a rank-ordered list based on the aggregated frequency counters.

Yet in another embodiment, the EHR system may incorporate an aspect of learning into the symptom prediction tool. As more users use the symptom prediction tool to enter more symptoms, the EHR system can learn the common relationships among symptoms based on previously entered symptoms. Thus, the EHR system may move away from having to process each encounter progress note for building the predictive model. Instead, the EHR system may collect data about which symptoms the users have entered and selected using the symptom prediction tool. Based on the learning of the collected data, the EHR system may build or modify the predictive model in the symptom prediction tool by creating additional mapping entries or updating the frequent counts of existing mapping entries.

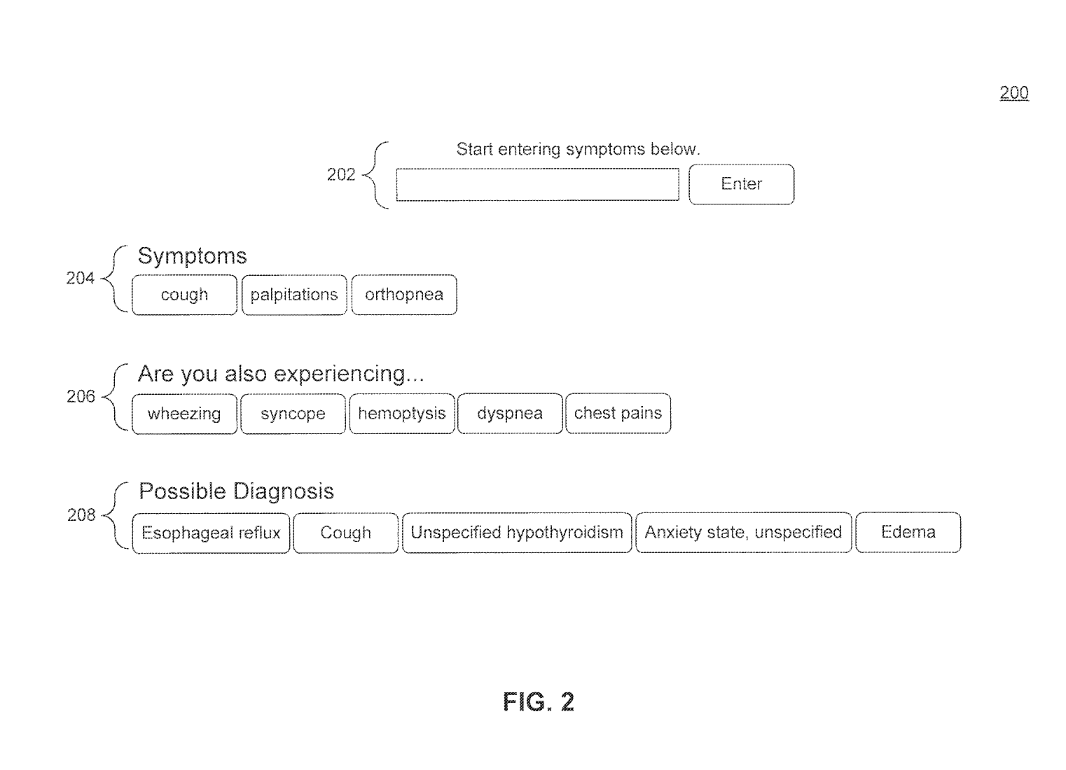

FIG. 2 shows screen 200 that illustrates a user interface utilizing the symptom prediction tool, as the result of method 100 described in FIG. 1. Screen 200 may be a part of a patient intake form GUI that helps a patient to select related symptoms based on the patient's reported symptom. Screen 200 may also be a part of a note-taking GUI that helps a physician to select related symptoms based on a patient's reported symptom.

Screen 200 includes symptom input section 202, symptom display section 204, related symptom section 206, and possible diagnosis section 208. An EHR user (e.g., a patient or a physician) may use symptom input section 202 to enter a symptom reported by the patient. Symptom display section 204 displays one or more symptoms entered by the EHR user. For example, the EHR user may type “cough” in a text field in symptom input section 202. After the user clicks the Enter button, symptom display section 204 may display “cough” as one symptom that the patient is experiencing. The EHR system receives the symptom reported by the patient in screen 200 and generates a related symptom according to, for example, method 100. The EHR system then outputs the related symptoms in related symptom section 206 for selection. If patient is also experiencing related symptom displayed in related symptom section 206, the EHR user may select the related symptom and screen 200 may add the selected related symptom in symptom display section 204. For example, the symptom prediction tool of the EHR system may determine that “hemoptysis” is a symptom related to the symptom “cough” reported by the patient. The EHR system outputs “hemoptysis” in related symptom section 206. If the patient also wants to report symptom “hemoptysis” using Screen 200, instead of typing the word “hemoptysis” in symptom input section 202, the EHR user may simply click the “hemoptysis” label in related symptom section 206. In response to the selection, Screen 200 may additionally display “hemoptysis” in symptom display section 204.

As discussed above, the symptom prediction tool can be used by a health care provider as a diagnosis helper. In some embodiments, the predictive model may also correlate one or more symptoms in symptom display section 204 with possible diagnosis learned by patient encounter notes. Thus, the EHR system may take the symptoms displayed in symptom display section 204 and use the predictive model to output possible diagnosis in possible diagnosis section 208.

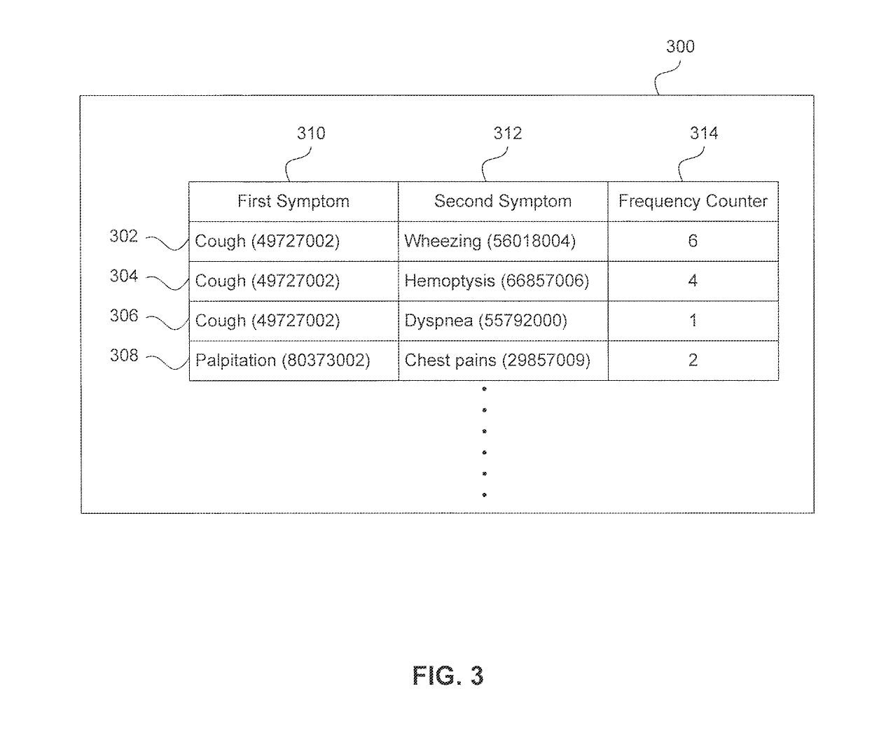

FIG. 3 shows an exemplary data structure in predictive model 300. Predictive model 300 may include a plurality of mapping entries. Each mapping entry correlates a first symptom in column 310 with a second symptom in column 312. In one embodiment, predictive model 300 may store symptoms in columns 310 and 312 in the free-text format in mapping entries. In another embodiment, predictive model 300 may store symptoms in columns 310 and 312 in corresponding SNOMED CT codes in mapping entries. For example, mapping entry 302 may store SNOMED CT code 49727002 (corresponding to “cough”) in column 310 for the first symptom. Also mapping entry 302 stores SNOMED CT code 56018004 (corresponding to “wheezing”) in column 312 for the second symptom. In this way, mapping entry 302 establishes a correlation between “cough” the first symptom) and “wheezing” (the second symptom). Similarly, mapping entry 304 establishes a correlation between “cough” and “hemoptysis,” mapping entry 306 establishes a correlation between “cough” and “dyspnea,” and mapping entry 308 establishes a correlation between “palpitation” and “chest pains.”

Mapping entries 302-308 may be the result of building predictive model 300 as described in step 102 of method 100. For example, the EHR system may process a patient encounter note. The patient encounter note includes “cough” in the chief complaint section and “wheezing” in the subjective component of the note. Consequently, the EHR system may create mapping entry 302 in predictive model 300.

Mapping entries in predictive model 300 may help the EHR system to predict related symptoms as described in steps 104-106 of method 100. For example, when the EHR system receives “cough” as the symptom reported by a patient, the EHR system may parse the free-text “cough” into a corresponding SNOMED CT code. Then the EHR system uses predictive model 300 to determine that mapping entry 302 has its first symptom field matching the SNOMED CT code for “cough” and generates “wheezing” as the related symptom. In addition, mapping entries in predictive model 300 allow a server device running the EHR system to perform faster search as compared to computer implementations that provide suggested symptoms only by sifting through patient encounter notes. Improved search efficiency of the server device is important to meet the interactive nature of the patient intake form GUI or the physician note-taking GUI illustrated in FIG. 2 because the related symptoms need to be displayed near real time as an EHR user types in reported symptoms in the GUI. Moreover, saving mapping entries using SNOMED CT codes consumes less memory and disk space for the server device than saving symptoms in the free-text format. Also, mapping entries using SNOMED CT codes improves the search performance of the server device even further as a search based on SNOMED CT codes runs faster than a search based on free-text comparison. Such performance gain on the server device by using SNOMED CT codes cannot be replicated by human beings because a physician or a patient lacks the capabilities of comparing and searching SNOMED CT codes accurately and quickly.

As shown in FIG. 3, multiple mapping entries in the predictive model may have the same first symptom. This may be the case because one patient encounter note may record multiple additional symptoms in other sections of the subjective component as being pertinent to a symptom in the chief complaint section. Additionally, different patient encounter notes may have the same symptom in the chief complaint sections of these patient encounter notes. These different patient encounter notes may however record different additional symptoms as being pertinent to the same symptom in the chief complaint section. Accordingly, the EHR system may select all mapping entries whose first symptom fields match the reported symptom, and the EHR system may generate a list of all related symptoms stored in second symptoms of these mapping entries in predictive model 300.

In some cases, however, generating a list of all related symptoms may not be desirable. For example, the list may be too long, and a long list of related symptoms in the GUI may clog the display screen. In addition, some symptoms may only be minimally related to the reported symptom, and displaying these minimally related symptoms could distract an EHR user from choosing other related symptoms that are more relevant. Thus, the EHR system may employ certain criteria to generate a subset of the list of all related symptoms.

In some embodiments, the EHR system utilizes frequency counter to select mapping entries for generating related symptoms. In predictive model 300, each mapping entry has a frequency counter field (column 314). The frequency counter in a mapping entry counts the frequency of a first symptom and a second symptom coexisting in multiple patient encounter notes. A higher frequency counter value usually indicates that the second symptom is more related to the first symptom. For example, a frequency counter value of 6 in mapping entry 302 results from “cough” and “wheezing” coexisting in 6 different patient encounter notes. Similarly, mapping entry 304 shows that “cough” and “hemoptysis” coexist in 4 different patient encounter notes, and mapping entry 306 shows that “cough” and “dyspnea” coexist in 1 single patient encounter note. These frequency counter numbers indicates that symptom “wheezing” is more related to “cough” than symptom “hemoptysis” and symptom “hemoptysis” is more related to “cough” than symptom “dyspnea.”

When multiple mapping entries with their first symptom fields match the reported symptom, the EHR system may select mapping entries whose frequency counters exceed a predetermined threshold value. For example, if the predetermined threshold value is 3, then the EHR system may select mapping entries 302 and 304 to generate related symptoms to “cough.” The EHR system may skip selecting mapping entry 306 because its frequency counter value is below the threshold value.

In another embodiment, the EHR system may rank the mapping entries by their frequency counter values, and select a predetermined number of mapping entries with the highest frequency counter values. For example, the EHR system may decide to select at most two mapping entries for each reported symptom. Thus, the EHR system may select mapping entries 302 and 304 because these two mapping entries have the two highest frequency counter value.

Predictive model 300 in FIG. 3 illustrates embodiments that utilize one set of mapping entries. In other embodiments, the EHR system may build two sets of mapping entries for predicting related symptoms. The first set (mapping table A) is built from first symptoms in the chief complaint section and second symptoms that exist in both the chief complaint section and the subjective component. The second set (mapping table B) is built from first symptoms in the rest of the subjective component and other second symptoms in the subjective component. When a patient reports more than one symptoms, for the first reported symptom that an EHR user provides, the EHR system searches through mapping table A for related symptoms. For subsequent reported symptoms (second and onwards), the system searches through mapping table B for related symptoms. After finding all mapping entries in mapping table A that contain the first reported symptom in the first symptom column and all mapping entries in mapping table B that contain the subsequent, second, third, etc., reported symptoms in the first symptom column, the EHR system aggregates all the resulting mapping entries. In the case where the ranking methodology is based on the frequency counter, the EHR system sums up the frequency counters of all occurrences to return one final list of distinct related symptoms where each symptom in the list has a frequency counter associated with the symptom.

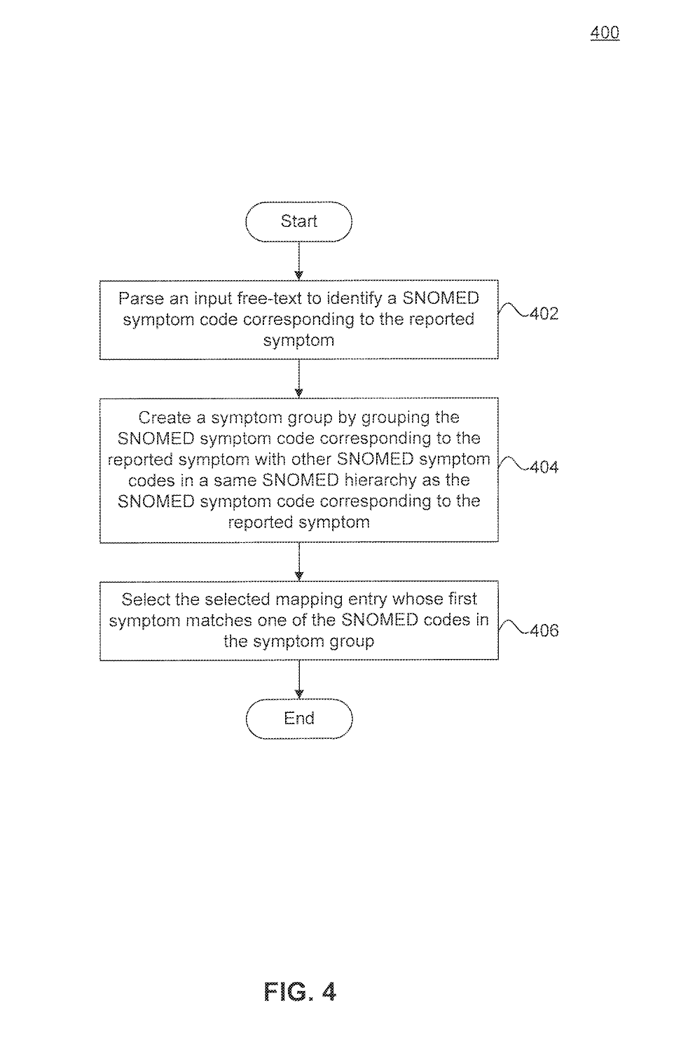

In some other cases, the EHR system may want to expand the list of related symptoms. This is the case because some related symptoms might not coexist in the same patient encounter note with a first symptom recorded in the chief complaint section. However, these related symptoms may coexist with other symptoms in the same SNOMED CT hierarchy as the first symptom. FIG. 4 is a flowchart showing method 400 for selecting mapping entries based on a group of symptoms in the same SNOMED CT hierarchy. Method 400 illustrates one alternative implementation of step 106 of method 100 as described in FIG. 1.

Method 400 expands the search for related symptoms by utilizing the hierarchical structure of the SNOMED CT system. Method 400 may expand the “search key” from a single reported symptom to a group of symptoms that are in the same SNOMED CT hierarchy as the reported symptom. Method 400 starts at step 402. After the EHR system receives a symptom reported by a patient, the EHR system first parses the symptom in the free-text format to identify a corresponding SNOMED CT symptom code.

At step 404, the EHR system creates a symptom group by grouping the corresponding SNOMED CT symptom code with other SNOMED CT symptom codes in the same SNOMED CT hierarchy as the corresponding SNOMED CT symptom code. Symptoms are in the same SNOMED CT hierarchy as a reported symptom if these symptoms have a parent-child relationship with the reported system (or even grandparent-grandchild relationship, etc.). Synonyms may also be in the same SNOMED CT hierarchy as the reported symptom. For example, symptom “chesty cough” is in the same SNOMED CT hierarchy as symptom “cough” because “chesty cough” is a child of “cough” in the SNOMED CT system. Accordingly, the EHR system may create the symptom group that include 49727002 (SNOMED CT code for “cough”), 161929000 (SNOMED CT code for “chesty cough”), plus other SNOMED CT codes for other symptoms that are in the same hierarchy as “cough” (“dry cough,” “allergic cough,” “barking cough,” etc.).

At step 406, the EHR system selects one or more mapping entries whose first symptoms match one of the SNOMED CT symptom codes in the symptom group. For example, even if a predictive model does not have a mapping entry that correlates “cough” with “hemoptysis,” the EHR system may nevertheless select a mapping entry that correlates “chesty cough” with “hemoptysis” and generates “hemoptysis” as a related symptom to the reported “cough” symptom.

### System

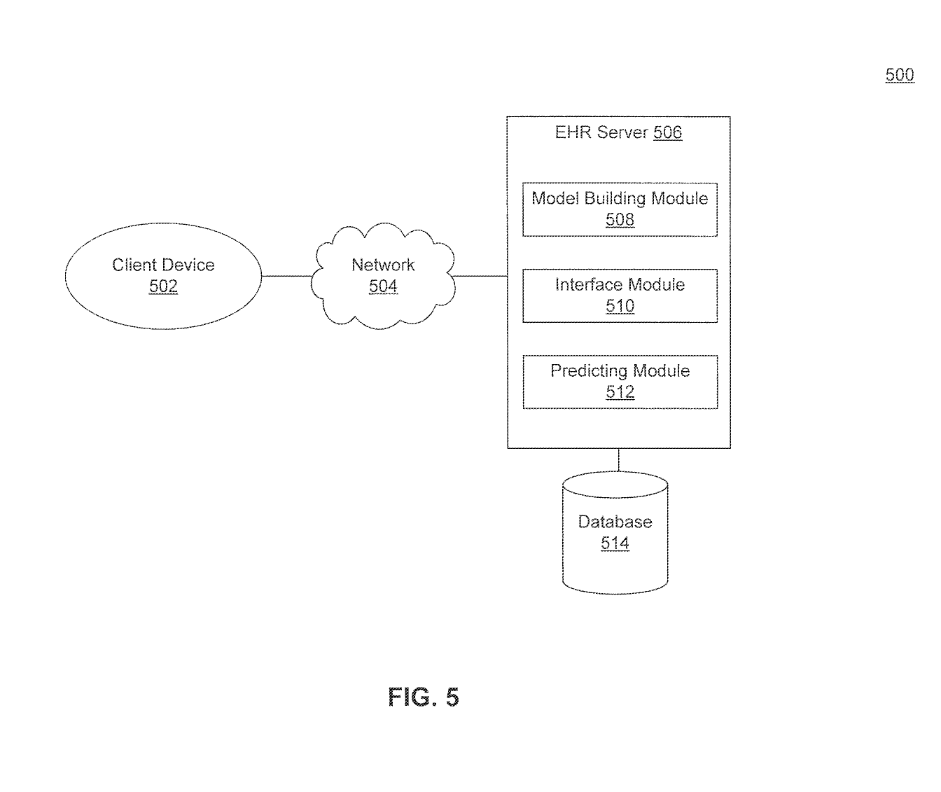

FIG. 5 is a diagram illustrating an example system 500 that implements the symptom prediction tool.

System 500 includes client device 502 and EHR server 506 connected by one or more networks 504, such as the Internet. EHR server 506 is coupled to one or more databases. For example, EHR server 506 may be coupled to database 514. EHR server 506 may be part of a comprehensive EHR system, as described in further detail below. An EHR user (e.g., a patient or a physician) may use client device 502 to communicate with EHR server 506. Example EHR server 506 and client device 502 include, but not limited to, any type of processing device including a computer, workstation, distributed computing system, embedded system, stand-alone electronic device, networked device, mobile device (such as a smartphone, tablet computer or laptop computer), set-top box, television or other type of processor or computer system.

To provide a symptom prediction tool, EHR server 506 may operate as described above for FIGS. 1-4, in the embodiment of FIG. 5, EHS server 506 includes three modules: model building module 508, interface module 510 and predicting module 512. Each module is described below in turn.

Model building module 508 determines a plurality of mapping entries to build a predictive model. Each mapping entry specifies a correlation between a first symptom and a second symptom in at least one patient encounter note. A patient encounter note describes an encounter between a patient and physician. A patient encounter note may include a subjective component describing the patient's current condition in a narrative form Model building module 508 may process patient encounter notes stored in database 514. For each patient encounter note, model building module 508 may extract the first symptom from the chief complaint section in the patient encounter note. Model building module 508 may extract the second symptom from other sections of the subjective component in the same patient encounter note.

In some embodiments, model building module 508 may store the correlated first symptom and the second symptom in corresponding SNOMED CT codes in the mapping entries. Thus, model building module 508 may extract the first and the second symptoms by parsing the first and the second symptoms in the free-text format to corresponding SNOMED CT codes. Then model building module 508 saves the SNOMED CT code corresponding to the first symptom and the SNOMED CT code corresponding to the second symptom in a mapping entry.

After model building module 508 completes building the predictive model, model building module 508 may save the predictive model in database 514.

Interface module 510 interacts with client device 502 over network 504. A patient may use client device 502 to report a symptom that the patient is experiencing. The patient may enter the reported symptom in a patient intake form displayed in a GUI on client device 502. A patient may also report the symptom to a physician, and the physician may use client device 502 to type in the reported symptom in a transcript note-taking portion of the GUI displayed on client device 502. After the patient or the physician uses client device 502 to enter the reported symptom, interface module 510 may receive the reported symptom via network 504. Then interface module 510 forwards the reported symptom to predicting module 512.

Predicting module 512 uses the predictive model saved in database 514 to select which of the mapping entries corresponds to the reported symptom to generate a related symptom. The selected mapping entry correlates the related symptom (i.e., the second symptom) with the reported symptom the first symptom). If the mapping entries in the predictive model store symptoms in the SNOMED CT code format, predicting module 512 may parse the reported symptom in the free-text format to identify a corresponding SNOMED CT symptom code. Then predicting module 512 selects the mapping entry whose first symptom matches the corresponding SNOMED CT symptom code of the reported symptom.

In some embodiments, multiple mapping entries may have the same first symptom that matches the reported symptom. Predicting module 512 may select all matching mapping entries and generate a list of related symptoms from those matching mapping entries. In other embodiments, predicting module may select a subset of all matching mapping entries. Predicting module 512 may utilize the frequency counter in each mapping entry to select a subset of all matching mapping entries. A frequency counter in a mapping entry counts the frequency of the first symptom and the second symptom coexisting in a plurality of patient encounter notes. Model building module 508 may keep track of the frequency counter in each mapping entry when processing the plurality of patient encounter notes. In one embodiment, predicting module 512 may select mapping entries whose frequency counters exceed a predetermined threshold value. In another embodiment, predicting module 512 may rank the mapping entries by their frequency counter values, and select a predetermined number of mapping entries with the highest frequency counter values.

If the mapping entries store the correlated first symptoms and second symptoms in the SNOMED CT code format, predicting module 512 may expand the search for related symptoms by creating a symptom group. The symptom group groups the SNOMED CT symptom code corresponding to the reported symptom with other SNOMED CT symptom codes in the same SNOMED CT hierarchy as the corresponding SNOMED CT symptom code. Predicting module 512 may use the symptom group to select mapping entries. For example, predicting module 512 may select a mapping entry whose first symptom matches one of the SNOMED CT codes in the symptom group. Then predicting module 512 generates the related symptoms from the selected mapping entries.

After predicting module 512 generates one or more related symptoms, interface module 510 outputs one or more related symptoms for selection.

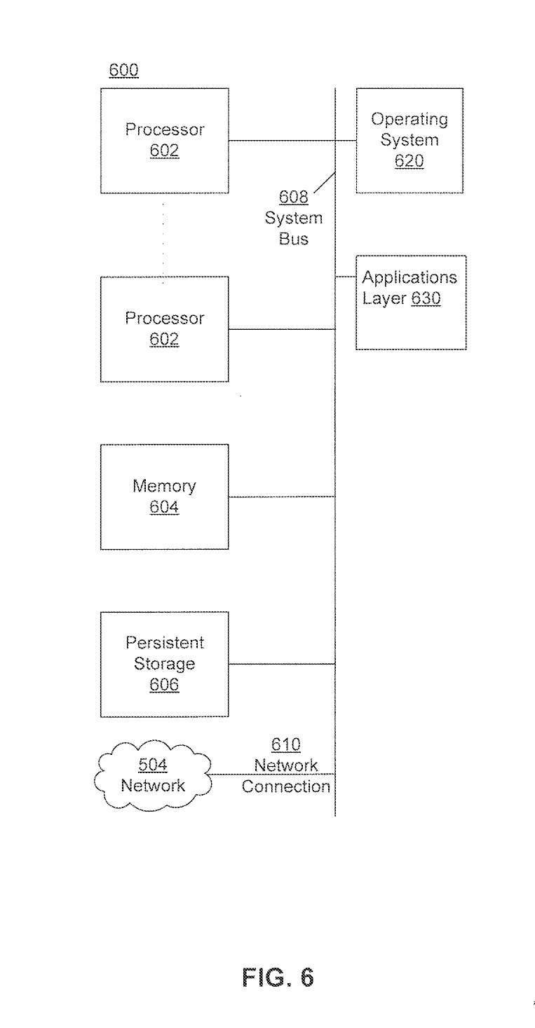

FIG. 6 illustrates an example computing device. FIG. 6 is a diagram illustrating a computing device 600 that accesses a network 504 over a network connection 610 that provides computing device 600 with telecommunications capabilities. Computing device 600 uses an operating system 620 as software that manages hardware resources and coordinates the interface between hardware and software.

In an embodiment, computing device 600 contains a combination of hardware, software and firmware constituent parts that allow it to run an applications layer 630. Computing device 600, in embodiments, may be organized around a system bus 608, but any type of infrastructure that allows the hardware infrastructure elements of computing device 600 to communicate with and interact with each other may also be used.

Processing tasks in the embodiment of FIG. 6 are carried out by one or more processors 602. However, it should be noted that various types of processing technology may be used here, including multi-core processors, multiple processors or distributed processors. Additional specialized processing resources such as graphics, multimedia or mathematical processing capabilities may also be used to aid in certain processing tasks. These processing resources may be hardware, software or an appropriate combination thereof. For example, one or more of processors 602 may be a graphics-processing unit (CPU). In an embodiment, a CPU is a processor that is a specialized electronic circuit designed to rapidly process mathematically intensive applications on electronic devices. The CPU may have a highly parallel structure that is efficient for parallel processing of large blocks of data, such as mathematically intensive data common to computer graphics applications, images and videos.

To manipulate data in accordance with embodiments described herein, processors 602 access a memory 604 via system bus 608. Memory 604 is nontransitory memory, such as random access memory (RAM). Memory 604 may include one or more levels of cache. Memory 604 has stored therein control logic (i.e., computer software) and/or data. For data that needs to be stored more permanently, processors 602 access persistent storage 606 via system bus 608. Persistent storage 606 may include, for example, a hard disk drive and/or a removable storage device or drive. A removable storage drive may be an optical storage device, a compact disc drive, flash memory, a floppy disk drive, a magnetic tape drive, tape backup device and/or any other storage device/drive.

Processors 602, memory 604 and persistent storage 606 cooperate with operating system 6201u provide basic functionality for computing device 600. Operating system 620 provides support functionality for applications layer 630.

Network connection 610 enables computer device 600 to communicate and interact with any combination of remote devices, remote networks, remote entities, etc. For example, network connection 610 may allow computer device 600 to communicate with remote devices over network 504, which may be a wired and/or wireless network and which may include any combination of LANs, WANs, the Internet, etc. Control logic and/or data may be transmitted to and from computer device 600 via network connection 610.

Applications layer 630 may house various modules and components. For example, model building module 508, interface module 510 and predicting module 512 may be included in applications layer 630 when computing device 600 is used as EHR server 506.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory or memory chips. However, any other type of tangible, persistent storage that can serve in the role of providing instructions to a processor may be used to store the instructions in these embodiments.

### Comprehensive EHR System

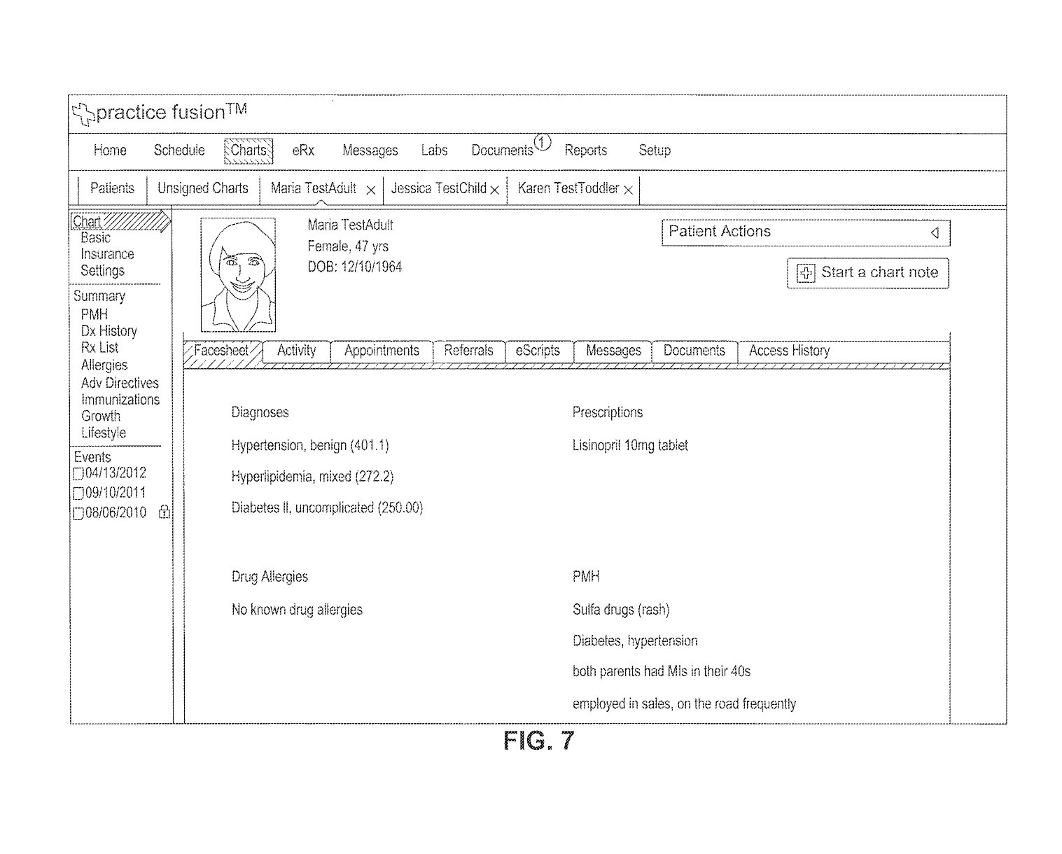

A comprehensive EHR system includes a variety of components. Components of EHR systems vary from vendor to vendor and from setting to setting. For example, an EHR system in which embodiments of the present invention can be used may also include: (1) an electronic prescription (eRx) component, (2) a clinical and radiology laboratory component, (3) a transfer of care component, (4) a scheduling component, (5) a billing service component and (6) patient portal component. FIG. 7 illustrates an example medical record.

The electronic prescription component provides medical professionals capabilities to electronically generate and transmit prescriptions for patients' medications. Some EHR systems enable prescribers to view their patients' prescription benefit information at the point of care and select medications that are on formulary and covered by the patient's drug benefit. This informs physicians of potential lower cost alternatives (such as generic drugs) and reduces administrative burden of pharmacy staff and physicians related to benefit coverage.

The clinical and radiology laboratory component allows medical professionals to integrate with clinical laboratories to electronically receive and incorporate clinical laboratory tests and results into a patient's chart and create computerized provider order entry (“CPOE”) clinical laboratory orders. This component can also support functionality that enables medical professionals to electronically receive and incorporate radiology laboratory test results (e.g., x-ray, ultrasound, MRI, PET/CT scan, mammography into a patient's chart.

Medical professionals can use the transfer of care component to transmit referrals electronically to other EHR users or to non-users by facsimile. Additionally, some EHR systems support electronically creating and transmitting consolidated continuity of care documents.

The scheduling component offers functionality that allows healthcare providers to manage their appointments with an electronic schedule that can be integrated into a practice's workflow.

The billing service component offers medical professionals the ability to electronically generate and transmit superbills. Superbills are the data source for the creation of a healthcare claim. The billing service component can transmit superbills to medical billing software accounts controlled by the professionals' offices or their billing service providers. This component also allows a healthcare professional to save a superbill and transmit it to the healthcare professional's billing account with the billing software vendor.

The patient portal component allows medical professionals to grant their patients an online means to view, download and transmit their health information, often called the personal health record (PHR). This component also provides patients with the ability to review their physicians and send and receive secure messages directly to and from their physicians.

Together, these components leverage the benefits of EHRs while mitigating the risks.

### Conclusion

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for predicting a related symptom, comprising:
(a) determining a plurality of mapping entries such that each mapping entry specifies a correlation between a first symptom and a second symptom in at least one patient encounter note that describes an encounter between a patient and a health practitioner to build a predictive model;
(b) receiving a reported symptom;
(c) selecting which of the plurality of mapping entries corresponds to the reported symptom to generate the related symptom, the related symptom being correlated in the selected mapping entry with the reported symptom; and
(d) outputting the related symptom for selection.

2. The method of claim 1, wherein the mapping entry comprises a frequency counter that counts a frequency of the first symptom and the second symptom coexisting in each of a plurality of patient encounter notes.

3. The method of claim 2, wherein the selecting (c) comprises:
selecting the selected mapping entry whose frequency counter exceeds a threshold value.

4. The method of claim 2, wherein
the receiving (b) further comprises receiving a second reported symptom;
the selecting (c) further comprises:
selecting which of the plurality of mapping entries correspond to one of the reported symptom and the second reported symptom,
aggregating the frequency counters based on the second symptom in each of the selected mapping entries, and
generating a rank-ordered list of related symptoms based on the aggregated frequency counters; and
the outputting (d) comprises outputting the rank-ordered list for selection.

5. The method of claim 2, wherein
the predictive model comprises a first set of mapping entries and a second set of mapping entries;
the at least one patient encounter note comprises a chief complaint section and a subjective component describing the patient's current condition in a narrative form;
the determining (a) comprises:
determining a plurality of mapping entries in the first set such that each mapping entry specifies a correlation between a first symptom in the chief complaint section and a second symptom in both the chief complaint section and the subjective component, and
determining a plurality of mapping entries in the second set such that each mapping entry specifies a correlation between a first symptom in other sections of the subjective component and a second symptom in the subjective component;
the receiving (b) further comprises receiving a second reported symptom;
the selecting (c) comprises:
selecting which of the plurality of mapping entries in the first set correspond to the reported symptom,
selecting which of the plurality of mapping entries in the second set correspond to the second reported symptom,
aggregating the frequency counters based on the second symptom in each of the selected mapping entries in the first and second sets, and
generating a rank-ordered list of related symptoms based on the aggregated frequency counters; and
the outputting (d) comprises outputting the rank-ordered list for selection.

6. The method of claim 1, wherein the at least one patient encounter note comprises a chief complaint section and a subjective component describing the patient's current condition in a narrative form, and the determining (a) comprises:
extracting the first symptom from the chief complaint section; and
extracting the second symptom from the subjective component.

7. The method of claim 6, wherein each extracting step comprises parsing free-text to identify a corresponding SNOMED CT symptom code.

8. The method of claim 7, wherein the selecting (c) comprises:
parsing an input free-text to identify a SNOMED CT symptom code corresponding to the reported symptom; and
selecting the selected mapping entry whose first symptom matches the SNOMED CT symptom code corresponding to the reported symptom.

9. The method of claim 7, wherein the selecting (c) comprises:
parsing an input free-text to identify a SNOMED CT symptom code corresponding to the reported symptom;
creating a symptom group by grouping the SNOMED CT symptom code corresponding to the reported symptom with other SNOMED CT symptom codes in a same SNOMED CT hierarchy as the SNOMED CT symptom code corresponding to the reported symptom; and
selecting the selected mapping entry whose first symptom matches one of the SNOMED CT codes in the symptom group.

10. A system for predicting a related symptom, comprising:
a computing device;
a database;
a model building module, implemented on the computing device, configured to determine a plurality of mapping entries such that each mapping entry specifies a correlation between a first symptom and a second symptom in at least one patient encounter note that describes an encounter between a patient and a health practitioner to build a predictive model;
an interface module, implemented on the computing device, configured to receive a reported symptom; and
a predicting module, implemented on the computing device, configured to select which of the plurality of mapping entries corresponds to the reported symptom to generate the related symptom, the related symptom being correlated in the selected mapping entry with the reported symptom,
wherein the interface module is further configured to output the related symptom for selection.

11. The system of claim 10, wherein the mapping entry comprises a frequency counter that counts a frequency of the first symptom and the second symptom coexisting in each of a plurality of patient encounter notes.

12. The system of claim 11, wherein the predicting module is configured to:
select the selected mapping entry whose frequency counter exceeds a threshold value.

13. The system of claim 11, wherein
the interface module is further configured to receive a second reported symptom;
the predicting module is further configured to:
select which of the plurality of mapping entries correspond to one of the reported symptom and the second reported symptom,
aggregate the frequency counters based on the second symptom in each of the selected mapping entries, and
generate a rank-ordered list of related symptoms based on the aggregated frequency counters; and
the interface module is further configured to output the rank-ordered list for selection.

14. The system of claim 11, wherein
the predictive model comprises a first set of mapping entries and a second set of mapping entries;
the at least one patient encounter note comprises a chief complaint section and a subjective component describing the patient's current condition in a narrative form;
the model building module is further configured to:
determine a plurality of mapping entries in the first set such that each mapping entry specifies a correlation between a first symptom in the chief complaint section and a second symptom in both the chief complaint section and the subjective component, and
determine a plurality of mapping entries in the second set such that each mapping entry specifies a correlation between a first symptom in other sections of the subjective component and a second symptom in the subjective component;
the interface module is further configured to receive a second reported symptom;
the predicting module is further configured to:
select which of the plurality of mapping entries in the first set correspond to the reported symptom,
select which of the plurality of mapping entries in the second set correspond to the second reported symptom,
aggregate the frequency counters based on the second symptom in each of the selected mapping entries in the first and second sets, and
generate a rank-ordered list of related symptoms based on the aggregated frequency counters; and
the interface module is further configured to output the rank-ordered list for selection.

15. The system of claim 10, wherein the at least one patient encounter note comprises a complaint section and a subjective component describing the patient's current condition in a narrative form, and the model building module is configured to:
extract the first symptom from the chief complaint section; and
extract the second symptom from the subjective component.

16. The system of claim 15, wherein the model building module is configured to:
extract each of the first and second symptoms by parsing free-text to identify a corresponding SNOMED CT symptom code.

17. The system of claim 16, wherein the predicting module is configured to:
parse an input free-text to identify a SNOMED CT symptom code corresponding to the reported symptom; and
select the selected mapping entry whose first symptom matches the SNOMED CT symptom code corresponding to the reported symptom.

18. The method of claim 16, wherein the predicting module is configured to:
parse an input free-text to identify a SNOMED CT symptom code corresponding to the reported symptom;
create a symptom group by grouping the SNOMED CT symptom code corresponding to the reported symptom with other SNOMED CT symptom codes in a same SNOMED CT hierarchy as the SNOMED CT symptom code corresponding to the reported symptom; and
select the selected mapping entry whose first symptom matches one of the SNOMED CT codes in the symptom group.

19. A program storage device tangibly embodying a program of instructions executable by at least one machine to perform a method for predicting a related symptom, said method comprising:
(a) determining a plurality of mapping entries such that each mapping entry specifies a correlation between a first symptom and a second symptom in at least one patient encounter note that describes an encounter between a patient and a health practitioner to build a predictive model;
(b) receiving a reported symptom;
(c) selecting which of the plurality of mapping entries corresponds to the reported symptom to generate the related symptom, the related symptom being correlated in the selected mapping entry with the reported symptom; and
(d) outputting the related symptom for selection.

20. The program storage device of claim 19, wherein the mapping entry comprises a frequency counter that counts a frequency of the first symptom and the second symptom coexisting in each of a plurality of patient encounter notes.

21. The program storage device of claim 20, wherein the selecting (c) comprises:
selecting the selected mapping entry whose frequency counter exceeds a threshold value.

22. The program storage device of claim 20, wherein
the receiving (b) further comprises receiving a second reported symptom;
the selecting (c) further comprises:
selecting which of the plurality of mapping entries correspond to one of the reported symptom and the second reported symptom,
aggregating the frequency counters based on the second symptom in each of the selected mapping entries, and
generating a rank-ordered list of related symptoms based on the aggregated frequency counters; and
the outputting (d) comprises outputting the rank-ordered list for selection.

23. The program storage device of claim 20, wherein
the predictive model comprises a first set of mapping entries and a second set of mapping entries;
the at least one patient encounter note comprises a chief complaint section and a subjective component describing the patient's current condition in a narrative form;
the determining (a) comprises:
determining a plurality of mapping entries in the first set such that each mapping entry specifies a correlation between a first symptom in the chief complaint section and a second symptom in both the chief complaint section and the subjective component, and
determining a plurality of mapping entries in the second set such that each mapping entry specifies a correlation between a first symptom in other sections of the subjective component and a second symptom in the subjective component;
the receiving (b) further comprises receiving a second reported symptom;
the selecting (c) comprises:
selecting which of the plurality of mapping entries in the first set correspond to the reported symptom,
selecting which of the plurality of mapping entries in the second set correspond to the second reported symptom,
aggregating the frequency counters based on the second symptom in each of the selected mapping entries in the first and second sets, and
generating a rank-ordered list of related symptoms based on the aggregated frequency counters; and
the outputting (d) comprises outputting the rank-ordered list for selection.

24. The program storage device of claim 19, wherein the at least one patient encounter note comprises a chief complaint section and a subjective component describing the patient's current condition in a narrative form, and the determining (a) comprises:
extracting the first symptom from the chief complaint section; and
extracting the second symptom from the subjective component.

25. The program storage device of claim 24, wherein each extracting step comprises parsing free-text to identify a corresponding SNOMED CT symptom code.

26. The program storage device of claim 25, wherein the selecting (c) comprises:
parsing an input free-text to identify a SNOMED CT symptom code corresponding to the reported symptom; and
selecting the selected mapping entry whose first symptom matches the SNOMED CT symptom code corresponding to the reported symptom.

27. The program storage device of claim 25, wherein the selecting (c) comprises:
parsing an input free-text to identify a SNOMED CT symptom code corresponding to the reported symptom;
creating a symptom group by grouping the SNOMED CT symptom code corresponding to the reported symptom with other SNOMED CT symptom codes in a same SNOMED CT hierarchy as the SNOMED CT symptom code corresponding to the reported symptom; and
selecting the selected mapping entry whose first symptom matches one of the SNOMED CT codes in the symptom group.
